(19) United States
(12) Patent Application Publication
(10) Pub. No.: US 2020/0285955 A1
(43) Pub. Date: Sep. 10, 2020

(54) METHOD FOR ACCELERATING DEEP LEARNING AND USER TERMINAL

(71) Applicant: HON HAI PRECISION INDUSTRY CO., LTD., New Taipei (TW)

(72) Inventors: CHIN-PIN KUO, New Taipei (TW); TUNG-TSO TSAI, New Taipei (TW); GUO-CHIN SUN, New Taipei (TW)

(21) Appl. No.: 16/508,390

(22) Filed: Jul. 11, 2019

(30) Foreign Application Priority Data
Mar. 8, 2019 (CN) 201910178362.2

(51) Int. Cl. G06N 3/08; G06N 3/04

(52) U.S. Cl. CPC G06N 3/08; G06N 3/04

(57) ABSTRACT

A method for accelerating deep learning includes calling up an entire deep learning architecture. Such architecture includes a data operation program of a convolutional layer and a data operation program of a fully connecting layer. A data operation program of the convolutional layer is obtained, the data operation program of the fully connecting layer is discarded, and the data operation program of the convolutional layer is loaded to a first processor. The data operation program for the fully connecting layer is then applied in similar manner to a second processor of the user terminal, the second processor continuing to perform operations on the fully connecting layer, thereby completing the entire deep learning architecture and training on the user terminal.

### FIELD

The subject matter herein generally relates to artificial intelligence.

### BACKGROUND

A deep learning method mimics a mechanism of the human brain in interpreting data, such as the data of images, sounds, and texts. Learning models established under different deep learning architectures are different. For example, Convolutional Neural Networks (CNNs) is a machine learning model under supervised learning and Deep Belief Nets (DBNs) is a machine learning model under unsupervised learning. The deep learning architecture based on CNNs has a high accuracy when processing information. However, the amounts of data and calculating of the deep learning architecture based on CNNs are huge. The calculation of the deep learning architecture based on CNNs can be successfully executed only on a cloud server. Additionally, a result of training needs to be sent to a terminal through a network, which is time-consuming and requires secure tunneling to ensure data security.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout several views.

FIG. 1 shows an application environment of a method for accelerating deep learning according to an embodiment of the present disclosure.

FIG. 2 is a flowchart of the method for accelerating deep learning according to an embodiment of the present disclosure.

FIG. 3 is a schematic diagram of a user terminal in an embodiment of the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

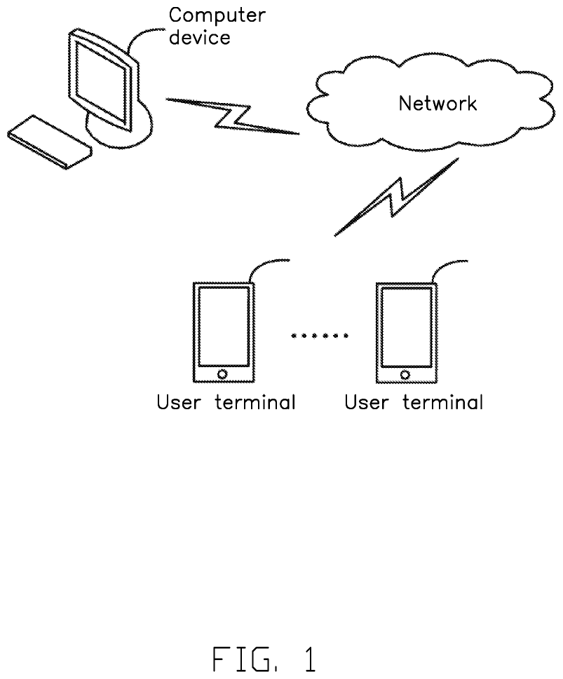

FIG. 1 illustrates an application environment of a method for accelerating deep learning according to an embodiment of the present disclosure. The method for accelerating deep learning is applied to a user terminal 1. The user terminal 1 establishes a communication with a computer device 2 through a network. The network may be a wired network or a wireless network, such as radio, WI-FI, cellular, satellite, broadcast, and the like.

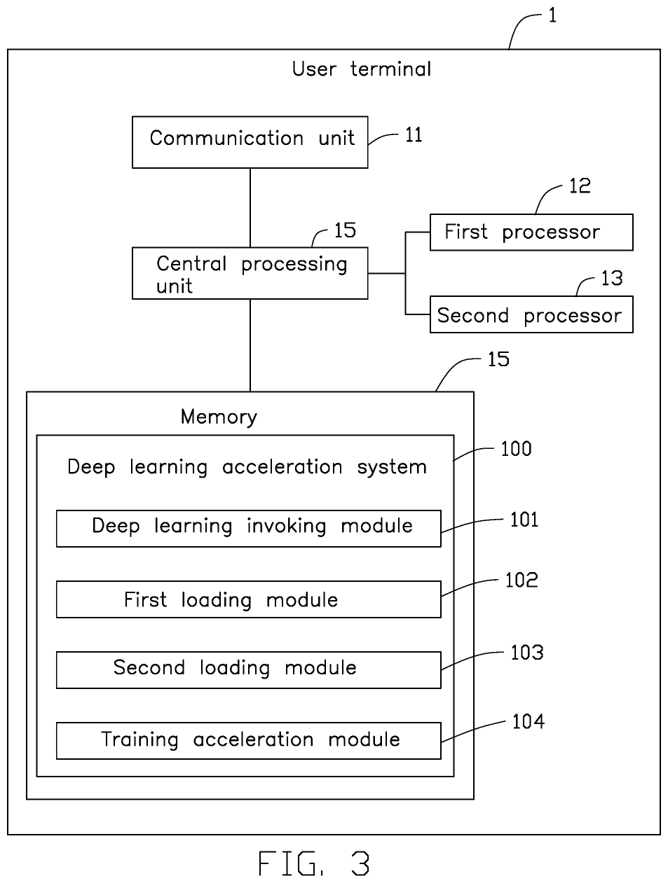

The user terminal 1 is an electronic device having deep learning optimization acceleration software. The user terminal 1 includes a communication unit 11, at least one first processor 12, at least one second processor 13, a central processing unit 14, and a memory 15. The hardware architecture of the user terminal 2 is shown in FIG. 3.

The communication unit 11 is configured to establish a communication with the computer device 2 and pass data. The computer device 2 stores an entire deep learning architecture. The entire deep learning architecture includes a data operation program of a convolutional layer and a data operation program of a fully connecting layer.

The first processor 12 is configured to load the data operation program of the convolutional layer.

The second processor 13 is configured to load the data operation program of the fully connecting layer corresponding to an application.

The central processing unit 14 may be a central processing unit (CPU), or may be another general-purpose processor, a digital signal processor (DSP), an application specific integrated circuit (ASIC), a Field-Programmable Gate Array (FPGA) or other programmable logic devices, discrete gates or transistor logic devices, discrete hardware components, or the like. A general-purpose processor can be a microprocessor. The central processing unit 14 can also be the first processor 12 or the second processor 13.

The memory 15 is used to store computer programs and/or modules/units. The first processor 12, the second processor 13, and the central processing unit 14 are used to implement various functions of the user terminal 1 by running or executing a computer program and/or a module/unit stored in the memory 15, and retrieving data stored in the memory 15.

The memory 15 may mainly include a storage program area and a storage data area. The storage program area may store an operating system, applications required for at least one function (such as a sound playing function or an image playing function), and the like. The storage data area may store data created according to the use of the user terminal 1, for example, the data operation program of the convolutional layer and the data operation program of the fully connecting layer.

Additionally, the memory 15 may include a random access memory, and may also include a non-volatile memory such as a hard disk, a memory, a plug-in hard disk, a smart memory card (SMC), and a secure digital (SD) card, flash card, at least one disk storage device, flash device, or other volatile solid-state storage device.

The computer device 1 can be a smart phone, a tablet computer, a laptop convenience computer, a desktop computer, or the like.

The computer device 2 may be a computer having a powerful computing processing function. The computer device 2 stores the data operation program of the convolutional layer and the data operation program of the fully connecting layer of the entire deep learning architecture. In this embodiment, the computer device 2 may be a personal computer, a server, or the like. The server may be a single server, a server cluster, a cloud server, or the like.

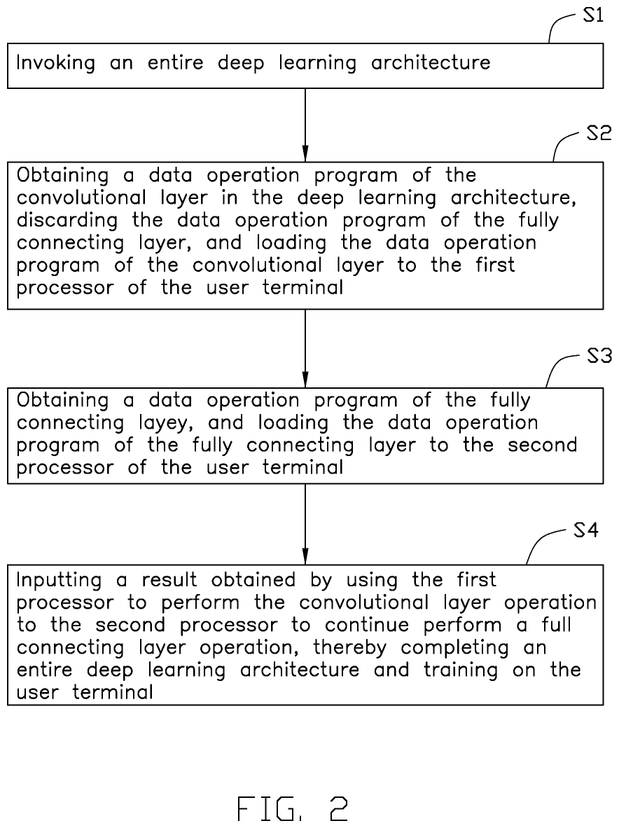

FIG. 2 illustrates a flowchart of a method for accelerating deep learning. The method is provided by way of example, as there are a variety of ways to carry out the method. Each block shown in FIG. 2 represents one or more processes, methods, or subroutines which are carried out in the example method. Furthermore, the order of blocks is illustrative only and additional blocks can be added or fewer blocks may be utilized without departing from the scope of this disclosure.

At block S1, an entire deep learning architecture is invoked. The entire deep learning architecture includes a data operation program of the convolutional layer and a data operation program of the fully connecting layer.

In this embodiment, the entire deep learning architecture is invoked from a computer device. For example, the computer device can be accessed through an API interface.

In one embodiment, the deep learning architecture is a neural network architecture based on VGG16. The deep learning architecture includes a convolutional layer and a fully connecting layer.

In one embodiment, the deep learning architecture is an architecture based on a neural network. The deep learning architecture includes thirteen convolutional layers and three fully connecting layers. The deep learning architecture is applied to an image recognition field.

In other embodiments, the number of convolutional layers can be adjusted according to the image recognition required. Similarly, the number of fully connecting layers can also be adjusted according to a complexity of an actual application. For example, if the complexity of the application is low and only one fully connecting layer can finish all of the functions, then one fully connecting layer is enough.

In this embodiment, an inputted image is an RGB image having a size of 224*224*3. “224*224” represents a size of the RGB image. “3” represents three channels of the RGB image. The RGB image is divided into an R layer, a G layer, and a B layer. Color information of each layer of the RGB image is represented by a color matrix. A range of the color values of each element in the color matrix is an integer from 0 to 255.

In this embodiment, a convolution kernel is used to construct a first convolutional layer. The convolution kernel is a 3*3 matrix with a step size of 1 as follows:

$$\begin{matrix}( \begin{matrix}1 & 0 & 1 \\ 0 & 1 & 0 \\ 1 & 0 & 1\end{matrix} ) \\ convolution kernel\end{matrix}$$

The value of each element in the matrix can be adjusted at any time according to the image recognition required. The image information of a fixed position of the image is enhanced by the convolution kernel.

In this embodiment, a convolution processing is performed on the first convolutional layer of the image by the elements in the convolution kernel matrix being respectively multiplied and summed with the elements of the R layer, the G layer, and the B layer of the image matrix.

After the first convolutional layer finishes the convolution processing, a new color matrix of the image is obtained. The value of the new color matrix is used as an input to a second convolutional layer. A new convolution kernel matrix is selected to perform the convolution processing on the second convolutional layer of the image, and so on. Different convolution kernel matrixes are selected to perform a convolution processing on the image matrix, until the convolution processing on a thirteenth convolutional layer of the image is completed, thereby obtaining a deep learning architecture with thirteen convolutional layers.

In other embodiments, if the required image recognition is satisfied by the convolution operation on the first convolutional layer, only one convolution operation may be selected. If the image enhancement is not significant after the convolution processing performed on the first convolutional layer, the same convolution kernel or a second convolution kernel can be used to perform the convolution processing on the second convolutional layer, and so on, until a satisfactory image recognition is achieved.

For example, in this embodiment, the second convolution kernel is obtained by changing the values of the elements of the convolution kernel matrix as follows:

$$\begin{matrix}( \begin{matrix}0 & 1 & 1 \\ 0 & 1 & 0 \\ 1 & 0 & 0\end{matrix} ) \\ second convolution kernel\end{matrix}$$

The image matrix processed by the convolution operation is used as an input to the fully connecting layer. The values of the convolutional layer are processed by an activation function operation and then is exported to the fully connecting layer. By the fully connecting layer, the data of the convolutional layer can be completely mapped to the fully connecting layer according to a specific rule. In one embodiment, the specific rule is different activation functions, and the number of the fully connecting layers and the number of neurons are designed according to different practical applications.

In other embodiments, the number of fully connecting layers and the number of neurons may be increased or decreased according to actual needs.

In the above embodiment, the entire deep learning architecture is completed according to the above method.

At block S2, a data operation program of the convolutional layer in the deep learning architecture is obtained. The data operation program of the fully connecting layer is discarded, and the data operation program of the convolutional layer is load to the first processor of the user terminal.

In other embodiments, before performing the step of loading the data operation program of the convolutional layer to the first processor of the user terminal, the method further determines whether the convolutional layer needs to be divided, according to the amount of data of the convolutional layer and a memory capacity of the first processor.

In this embodiment, if the amount of data of the convolutional layer exceeds a maximum capacity of the memory of the first processor, the convolutional layer needs to be divided according to a number of layers of the convolutional layer. The divided convolutional layers are respectively loaded to at least one first processor of the user terminal.

In this embodiment, the thirteen convolutional layers and the three fully connecting layers in the deep learning architecture are divided. The operation program of the thirteen convolutional layers is obtained and is loaded to the first processor. When the data amount of the thirteen convolutional layers exceeds the maximum capacity of one first processor, the thirteen convolutional layers are divided, for example, are divided into two parts, and the two divided parts are respectively loaded to two different first processors.

In this embodiment, the first processor is a dedicated processor for convolutional layer data calculation. The dedicated processor includes a Field-Programmable Gate Array (FPGA), a Digital Signal Processor (DSP), or an Application Specific Integrated Circuit (ASIC).

At block S3, a data operation program of the fully connecting layer is obtained, and the data operation program of the fully connecting layer is loaded to the second processor of the user terminal.

In this embodiment, the data operation program of the fully connecting layer corresponds to an application, and different applications correspond to different data operation programs of the fully connecting layer.

In this embodiment, different applications correspond to different data operation programs of the fully connecting layer. The number of layers in the fully connecting layer and/or the number of neurons, corresponding to different applications, are different.

In one embodiment, the application is an image recognition application. Then, the number of fully connecting layers designed for the image recognition application is 3. The number of neurons is 4096. The data processing program of the fully connecting layer is loaded to the second processor.

In another embodiment, the application is a voice recognition application. Then, the number of fully connecting layers designed for the voice recognition application is 2. The number of neurons is 2048. The data processing program of the fully connecting layer is loaded to the second processor.

At block S4, a result is input to the second processor to continue performing a processing or operation on the fully connecting layer, thereby completing an entire deep learning architecture and training on the user terminal.

In this embodiment, the result is obtained by the first processor performing convolution processing on the convolutional layer.

The user terminal includes any one of a smart phone, a tablet computer, a laptop convenient computer, and a desktop computer.

In one embodiment, the user terminal is a smart phone. The smart phone has at least two processors. The first processor stores an operation method of the convolutional layer. The second processor stores an operation method of the fully connecting layer. The design of the convolutional layer and the fully connected layer are obtained according to the blocks S1, S2, and S3. The smart phone has an entire deep learning architecture and can complete the training of the entire deep learning architecture.

FIG. 3 illustrates a deep learning acceleration system 100. The deep learning acceleration system 100 may include a plurality of functional modules composed of program code segments. The program code of each program segment in the deep learning acceleration system 100 may be stored in the memory 15 and executed by the first processor 12, the second processor 13, and the central processing unit 14, to implement the deep learning acceleration method.

In this embodiment, the deep learning acceleration system 100 may include a deep learning invoking module 101, a first loading module 102, a second loading module 103, and a training acceleration module 104.

The deep learning invoking module 101 calls up an entire deep learning architecture. The entire deep learning architecture includes a data operation program of the convolutional layer and a data operation program of the fully connecting layer.

In this embodiment, the entire deep learning architecture is taken from a computer device. For example, the computer device can be accessed through an API interface.

In one embodiment, the deep learning architecture is a neural network architecture based on VGG16. The deep learning architecture includes a convolutional layer and a fully connecting layer.

In one embodiment, the deep learning architecture is an architecture based on a neural network. The deep learning architecture includes thirteen convolutional layers and three fully connecting layers. The deep learning architecture is applied to image recognition.

In other embodiments, the number of convolutional layers can be adjusted according to the image recognition required. Similarly, the number of fully connecting layers can also be adjusted according to a complexity of an actual application. For example, if the complexity of the application is low and only one fully connecting layer can finish all of the functions, then one fully connecting layer is sufficient.

In this embodiment, an inputted image is an RGB image having a size of 224*224*3. “224*224” represents a size of the RGB image. “3” represents three channels of the RGB image. The RGB image is divided into an R layer, a G layer, and a B layer. Color information of each layer of the RGB image is represented by a color matrix. A range of the color values of each element in the color matrix is an integer from 0 to 255.

In this embodiment, a convolution kernel is used to construct a first convolutional layer. The convolution kernel is a 3*3 matrix and with a step size of 1 as follows:

$$\begin{matrix}( \begin{matrix}1 & 0 & 1 \\ 0 & 1 & 0 \\ 1 & 0 & 1\end{matrix} ) \\ convolution kernel\end{matrix}$$

The value of each element in the matrix can be adjusted at any time according to the image recognition required. The image information of a fixed position of the image is enhanced by the convolution kernel.

In this embodiment, a convolution processing is performed on the first convolutional layer of the image by the elements in the convolution kernel matrix being respectively multiplied and summed with the elements of the R layer, the G layer, and the B layer of the image matrix.

After the first convolutional layer finishes the convolution processing, a new color matrix of the image is obtained. The value of the new color matrix is used as an input to a second convolutional layer. A new convolution kernel matrix is selected to perform the convolution processing on the second convolutional layer of the image, and so on. Different convolution kernel matrixes are selected to perform a convolution processing on the image matrix, until the convolution processing on a thirteenth convolutional layer of the image is completed, thereby obtaining a deep learning architecture with thirteen convolutional layers.

In other embodiments, if the image recognition required is satisfied by the convolution operation on the first convolutional layer, only one convolution operation may be selected. If the image enhancement is not significant after the convolution processing performed on the first convolutional layer, the same convolution kernel or a second convolution kernel can be used to perform the convolution processing on the second convolutional layer, and so on, until a satisfactory image recognition is achieved.

For example, in this embodiment, the second convolution kernel is obtained by changing the values of the elements of the convolution kernel matrix as follows:

$$\begin{matrix}( \begin{matrix}0 & 1 & 1 \\ 0 & 1 & 0 \\ 1 & 0 & 0\end{matrix} ) \\ second convolution kernel\end{matrix}$$

The image matrix processed by the convolution operation is used as an input layer to the fully connecting layer. The values of the convolutional layer are processed by an activation function operation and then exported to the fully connecting layer. By the fully connecting layer, the data of the convolutional layer can be completely mapped to the fully connecting layer according to a specific rule. In one embodiment, the specific rule is different activation functions, and the number of fully connecting layers and the number of neurons are designed according to different practical applications.

In other embodiments, the number of fully connecting layers and the number of neurons may be increased or decreased according to actual needs.

In the above embodiment, the entire deep learning architecture is completed according to the above method.

The first loading module 102 is used to obtain a data operation program of the convolutional layer in the deep learning architecture, to discard the data operation program of the fully connecting layer, and to load the data operation program of the convolutional layer into the first processor of the user terminal.

In other embodiments, before performing the step of loading the data operation program of the convolutional layer to the first processor of the user terminal, the method further determines whether the convolutional layer needs to be divided, according to the amount of data of the convolutional layer and memory capacity of the first processor.

In this embodiment, if the amount of data of the convolutional layer exceeds a maximum capacity of the memory of the first processor, the convolutional layer needs to be divided according to a number of layers of the convolutional layer. The divided convolutional layers are respectively loaded to at least one first processor of the user terminal.

In this embodiment, the thirteen convolutional layers and the three fully connecting layers in the deep learning architecture are divided. The operation program of the thirteen convolutional layers is obtained and is loaded to the first processor. When the data amount of the thirteen convolutional layers exceeds the maximum capacity of one first processor, the thirteen convolutional layers are divided, for example, are divided into two parts, and the two divided parts are respectively loaded to two different first processors.

In this embodiment, the first processor is a dedicated processor for convolutional layer data calculation. The dedicated processor includes a Field-Programmable Gate Array (FPGA), a Digital Signal Processor (DSP), or an Application Specific Integrated Circuit (ASIC).

The second loading module 103 is used to obtain a data operation program of the fully connecting layer, and to load the data operation program of the fully connecting layer to the second processor of the user terminal.

In this embodiment, the data operation program of the fully connecting layer corresponds to an application, and different applications correspond to different data operation programs of the fully connecting layer.

In this embodiment, different applications correspond to different data operation programs of the fully connecting layer. The number of layers in the fully connecting layer and/or the number of neurons, corresponding to different applications, are different.

In one embodiment, the application is an image recognition application. Then, the number of fully connecting layers designed for the image recognition application is 3. The number of neurons is 4096. The data processing program of the fully connecting layer is loaded to the second processor.

In another embodiment, the application is a voice recognition application. Then, the number of fully connecting layers designed for the voice recognition application is 2. The number of neurons is 2048. The data processing program of the fully connecting layer is loaded to the second processor.

The training acceleration module 104 inputs a result to the second processor, to continue performing a processing or operation on the fully connecting layer, thereby completing an entire deep learning architecture and training on the user terminal. In this embodiment, the result is obtained by the first processor performing convolution processing on the convolutional layer.

The user terminal includes any one of a smart phone, a tablet computer, a laptop convenient computer, and a desktop computer.

In one embodiment, the user terminal is a smart phone. The smart phone has at least two processors. The first processor stores an operation method of the convolutional layer. The second processor stores an operation method of the fully connecting layer. The design of the convolutional layer and the fully connected layer are obtained according to the blocks S1, S2, and S3. The smart phone has an entire deep learning architecture and can complete the training of the entire deep learning architecture.

In the several embodiments provided by the present disclosure, it should be understood that the disclosed computer apparatus and method may be implemented in other manner. For example, the computing device embodiments described above are merely illustrative. For example, the division of a unit is only a logical function division, and actual implementation may have another manner of division.

In addition, each functional unit in each embodiment of the present disclosure may be integrated in the same processing unit, or each unit may exist physically separately, or two or more units may be integrated in the same unit. The above integrated unit can be implemented in the form of hardware or in the form of hardware plus software function modules.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A method for accelerating deep learning, the method comprising:
invoking an entire deep learning architecture, the entire deep learning architecture comprising a data operation program of the convolutional layer and a data operation program of the fully connecting layer;
obtaining the data operation program of the convolutional layer, discarding the data operation program of the fully connecting layer, and loading the data operation program of the convolutional layer to a first processor of a user terminal;
obtaining the data operation program of the fully connecting layer, loading the data operation program of the fully connecting layer to a second processor of the user terminal; and
inputting a result to the second processor to continue performing an operation on the fully connecting layer, thereby completing the entire deep learning architecture and training on the user terminal; wherein the result is obtained by the first processor performing convolution processing on the convolutional layer.

2. The method of claim 1, wherein the deep learning architecture is a neural network architecture based on VGG16.

3. The method of claim 1, wherein before loading the data operation program of the convolutional layer to the first processor of the user terminal, the method further comprises:
determining whether the convolutional layer needs to be divided, according to an amount of data of the convolutional layer and a memory capacity of the first processor.

4. The method of claim 3, wherein when the amount of data of the convolutional layer exceeds a maximum memory capacity of the first processor, the convolutional layer is divided according to a number of layers of the convolutional layer, and the divided convolutional layers are respectively loaded to another first processor of the user terminal.

5. The method of claim 1, wherein the first processor is a dedicated processor for convolutional layer data calculation, the processor is one of a Field-Programmable Gate Array (FPGA), a Digital Signal Processor (DSP), and an Application Specific Integrated Circuit (ASIC).

6. The method of claim 1, wherein the data operation program of the fully connecting layer corresponds to an application, different applications correspond to different data operation programs of the fully connecting layer.

7. The method of claim 6, wherein different applications corresponding to different data operation programs of the fully connecting layer comprises the number of layers in the fully connecting layer and/or the number of neurons, corresponding to different applications, are different.

8. The method of claim 1, wherein the user terminal comprises any one of a smart phone, a tablet computer, a laptop convenient computer, and a desktop computer.

9. A user terminal comprising:
a communication unit, the communication unit establishing a communication with a computer device and passing data, the computer storing an entire deep learning architecture, the entire deep learning architecture comprising a data operation program of a convolutional layer and a data operation program of a fully connecting layer;
at least one first processor;
at least one second processor;
a central processing unit; and
a memory storing a plurality of instructions, which when executed by the central processing unit, cause the central processing unit to:
invoke an entire deep learning architecture, the entire deep learning architecture comprising a data operation program of the convolutional layer and a data operation program of the fully connecting layer;
obtain the data operation program of the convolutional layer, discard the data operation program of the fully connecting layer, and load the data operation program of the convolutional layer to a first processor of a user terminal;
obtain the data operation program of the fully connecting layer, load the data operation program of the fully connecting layer to a second processor of the user terminal; and
input a result to the second processor to continue performing an operation on the fully connecting layer, thereby completing the entire deep learning architecture and training on the user terminal; wherein the result is obtained by the first processor performing convolution processing on the convolutional layer.

10. The user terminal of claim 9, wherein the deep learning architecture is a neural network architecture based on VGG16.

11. The user terminal of claim 9, wherein when the instructions are executed by the central processing unit, further causes the central processing unit to:
determine whether the convolutional layer needs to be divided, according to an amount of data of the convolutional layer and a memory capacity of the first processor.

12. The user terminal of claim 11, wherein when the amount of data of the convolutional layer exceeds a maximum memory capacity of the first processor, the convolutional layer is divided according to a number of layers of the convolutional layer, and the divided convolutional layers are respectively loaded to another first processor of the user terminal.

13. The user terminal of claim 9, wherein the first processor is a dedicated processor for convolutional layer data calculation, the processor is one of a Field-Programmable Gate Array (FPGA), a Digital Signal Processor (DSP), and an Application Specific Integrated Circuit (ASIC).

14. The user terminal of claim 9, wherein the data operation program of the fully connecting layer corresponds to an application, different applications correspond to different data operation programs of the fully connecting layer.

15. The user terminal of claim 14, wherein different applications corresponding to different data operation programs of the fully connecting layer comprises the number of layers in the fully connecting layer and/or the number of neurons, corresponding to different applications, are different.

16. The user terminal of claim 14, wherein the user terminal comprises any one of a smart phone, a tablet computer, a laptop convenient computer, and a desktop computer.
